(19) United States
(12) Patent Application Publication
(10) Pub. No.: US 2024/0273346 A1
(43) Pub. Date: Aug. 15, 2024

(54) SELF-BALANCING MIXTURE OF EXPERTS

(71) Applicant: MICROSOFT TECHNOLOGY LICENSING, LLC, Redmond, WA (US)

(72) Inventors: Devangkumar Rameshbhai PATEL, Fremont, CA (US); Timothy Lawrence HARRIS, Cambridge (GB)

(21) Appl. No.: 18/109,156

(22) Filed: Feb. 13, 2023

(51) Int. Cl. G06N 3/063; G06N 3/042; G06N 3/098

(52) U.S. Cl. CPC G06N 3/063; G06N 3/042; G06N 3/098

(57) ABSTRACT

Methods are provided for identifying and redistributing the experts of MOE machine learning models that are distributed on different accelerators. Systems identify a set of input tokens to be routed to the plurality of experts and identify a routing assignment of the set of input tokens to the plurality of experts. After identifying a current distribution of the plurality of experts on the plurality of accelerators, systems determine a new distribution of the plurality of experts on the plurality of accelerators which will result in an improved processing efficiency of the set of input tokens by the plurality of accelerators based on the routing assignment of the set of tokens to the plurality of experts as compared to the current distribution of the plurality of experts on the plurality of accelerators. The new distribution of the plurality of experts is also applied to realize the anticipated improvements in processing efficiencies.

### BACKGROUND OF THE INVENTION

Machine learning models using mixture-of-expert (MOE) techniques are typically made up of N number of layers which are broadly classified as MOE layers and non-MOE layers. Various distribution strategies are used to distribute large MOE machine learning models into computing system hardware.

When a model is distributed according to conventional MOE distribution strategies, a single accelerator, or graphics processing unit (GPU) will be assigned some or all of the layers of the model, including MOE layers, as well as non-MOE layers. However, there are many problems associated with such distributions. For example, certain components will remain idle while other components are still processing input data. Furthermore, such models are not scalable because of the limitations of the current hardware devices of existing computing systems. Additionally, training MOE models that have many distributed layers and experts can be computationally heavy and time-consuming.

In view of the foregoing, there is an ongoing need for improved systems and methods for MOE machine learning models that can be distributed on different types of hardware configurations.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY OF THE INVENTION

Disclosed embodiments include systems and methods for distributing MOE models on different computing systems. In particular, systems and methods are provided for determining a new distribution of experts based on potential improvements to the processing efficiency of the computing system by self-balancing expert components of the MOE models on multiple accelerators.

Disclosed systems access computing systems having multiple experts distributed on different accelerators. The systems also identify routing assignments (e.g., a dataset or index table that correlates the relationship between input tokens, experts, and/or accelerators of a computing system) that set forth which input tokens will be routed to one or more of the experts. After identifying a current distribution of experts on the accelerators, the systems determine new distributions of the experts on the accelerators that will result in improved processing efficiency of the tokens by the different accelerators, based on comparing the routing assignment of the tokens with the current distribution of the experts for efficiently handling anticipated loads associated with the accelerators. Finally, the systems apply a new distribution of the experts on the accelerators to realize the anticipated improvements in processing efficiencies. In some instances, this new distribution is applied prior to the machine learning model actually receiving and/or processing the input tokens being routed to or through the MOE models instantiated and distributed on the accelerators.

Systems and methods are also provided for determining a new distribution during the run-time processing of the input tokens. For example, systems are able to identify a real-time or near-real-time processing imbalance of the input tokens based on the current distribution of experts on the accelerators. In response to identifying the processing imbalance, systems are able to determine a new distribution that will result in an improvement in the processing imbalance and apply the new distribution to the computing system.

Some systems and methods are also provided for determining a new distribution of experts after an initial processing iteration has been completed. For example, systems identify a historical processing record of input tokens by the machine learning model and identify a current distribution of the experts. Then, based on the historical processing record of the input tokens and the current distribution of experts, the systems determine a new distribution that will result in an improvement in the processing efficiency of the computing system and will apply the new distribution of the experts on the accelerators.

This summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the advantages and features of the systems and methods described herein can be obtained, a more particular description of the embodiments briefly described above will be rendered by reference to specific embodiments thereof which are illustrated in the appended drawings. Understanding that these drawings depict only typical embodiments of the systems and methods described herein, and are not therefore to be considered to be limiting in their scope, certain systems and methods will be described and explained with additional specificity and detail through the use of the accompanying drawings in which:

FIGS. 1A-1D illustrates various example embodiments of existing MOE systems.

FIG. 2 illustrates an example diagram of an MOE machine learning model distributed on a computing system according to the disclosed embodiments.

FIG. 3 illustrates a computing environment in which a computing system incorporates and/or is utilized to perform disclosed aspects of the disclosed embodiments.

FIGS. 4A-4E illustrate various embodiments of distributing experts on multiple accelerators.

FIGS. 5A-5B illustrate various embodiments of token routing assignments.

FIGS. 6A-6B illustrate various embodiments of accelerator capacity and expert location tracking.

FIGS. 7A-7B illustrate various embodiments of distributing shards of experts on multiple accelerators.

FIGS. 8-10 illustrate various embodiments of flow diagrams having a plurality of acts for distributing experts on a computing system.

### DETAILED DESCRIPTION OF THE INVENTION

Disclosed embodiments are directed towards systems and methods for distributing and/or redistributing expert components of an MOE machine learning model instance within the accelerators of a computing system. For instance, disclosed embodiments include identifying existing distributions of experts for an MOE machine learning model instance that are loaded or instantiated on different accelerators of a computing system to improve a processing efficiency and overall input token balance of the computing system.

It will be appreciated that some of the disclosed embodiments are specifically directed to improved systems and methods for determining a distribution of the machine learning model instance based on separating sparse layers from dense layers on customized hardware devices. This referenced distribution of the machine learning model instance refers to processes of identifying different layers of the machine learning model and assigning these different layers to different components of the computing system, wherein certain layers (or sets of layers) are stored and processed separately from one another by the different accelerators.

Byway of example, a mixture-of-experts machine learning model comprises a plurality of experts, which are each trained for a particular task. Each expert comprises one or more machine learning model layers, wherein each expert can be independently loaded and stored on an accelerator, independently of the other experts, and used to process inputs separately from the other experts. Accordingly, a mixture-of-experts machine learning model can be distributed or redistributed onto a computing system in a variety of different configurations, with different accelerators storing one or more of the experts to process inputs, as will be described in more detail below. During the referenced distributions and redistributions, an expert can be moved to or removed from corresponding accelerators. This may also include relocating an expert from one accelerator to another accelerator, in entirely or in part, as described in more detail below.

In view of the foregoing, the references to determining a distribution of the machine learning model or machine learning model instance refers to the assignment, planning, or organization of the different layers for different components (e.g., accelerators) of the computing system. Whereas the references to the application of the distribution refers to processes in which the layers or experts of a machine learning model are separated out, stored on, and processed by the different components of the computing system according to the distribution (e.g., distribution scheme).

The disclosed embodiments provide many technical advantages over existing systems. For example, some accelerators (e.g., GPU or other processors) may become overloaded based on how many tokens are assigned for processing by the expert components of the model that are disposed on the corresponding accelerators. Notably, if an accelerator becomes overloaded, it may drop an input token, which can significantly degrade the overall throughput and quality of outputs processed by the machine learning model.

Additionally, or alternatively, even if an accelerator is not overloaded, it may be out of balance compared to other accelerators which may be underutilized. In this case, it is still beneficial to relocate or exchange an expert over to an underutilized accelerator in order to improve the processing efficiency of the computing system. Thus, the disclosed embodiments are directed to distributing and redistributing experts on the computing system at one or more different times in the processing steps. By implementing systems in this manner, systems are able to automatically self-balance the distribution of experts on the different accelerators available in the systems.

In addition, conventional transformer-based machine learning models are constructed using a stack of transformer layers that process input data in a sequence. For example, the output from a previous transformer layer is used as input to the next transformer layer. All neurons from a typical transformer layer participate in processing each input. Transformer layers that employ all or most of the neurons within the layer are identified as dense layers, while transformer layers that employ one or a limited number of neurons within the layer are identified as sparse layers. Dense layers require a high number of floating-point operations (FLOPS) and a large amount of GPU memory to process inputs. Machine learning models which are configured in this manner with dense layers are difficult to scale.

Some data scientists have started using a variant of the traditional transformer layer, which has come to be known as a mixture of experts (MOE) layer as a way to scale the machine learning models. MOE layers, in some instances, which are a type of sparse layer, are built using a collection of experts. For example, if a model is being trained to perform a particular task, that particular task (e.g., a predictive modeling task) can be decomposed into two or more sub-tasks. Each expert is then trained on one of the sub-tasks. While in some instances, the experts are configured as models, such as a neural network having its own set of nodes or neurons, the experts can also be referred to as nodes or neurons when the collection of experts within a particular machine learning model layerforms a neural network. Thus, in the case of the MOE layer (i.e., sparse layer), each input can be processed by a limited subset of experts (i.e., neurons) from the MOE layer.

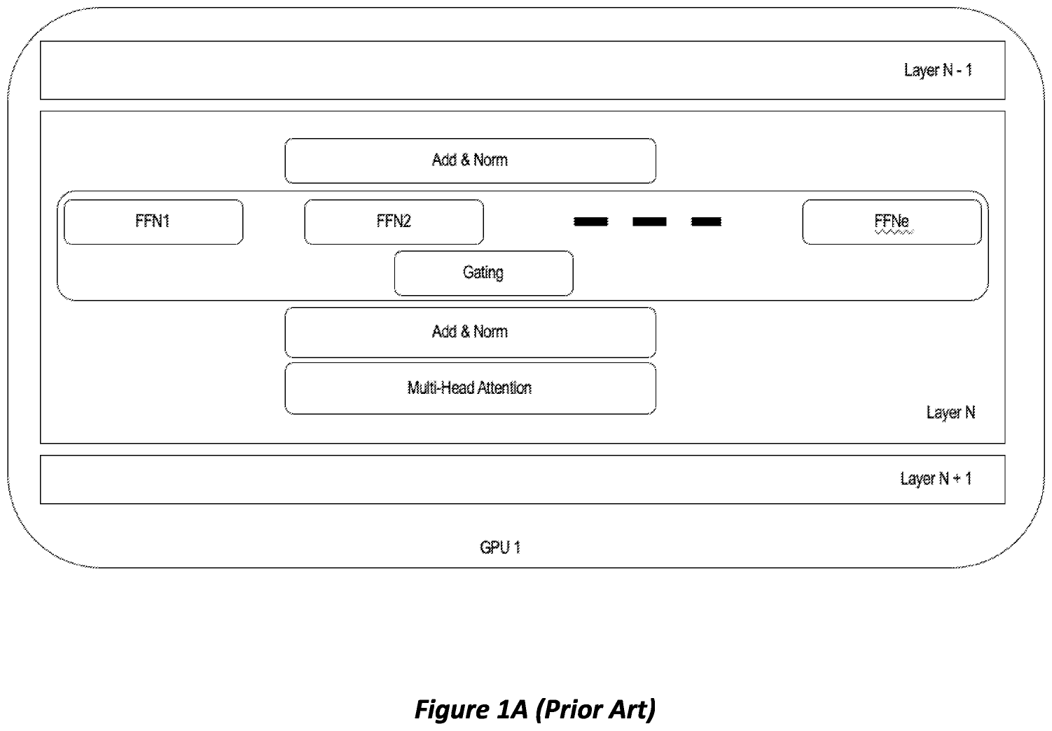

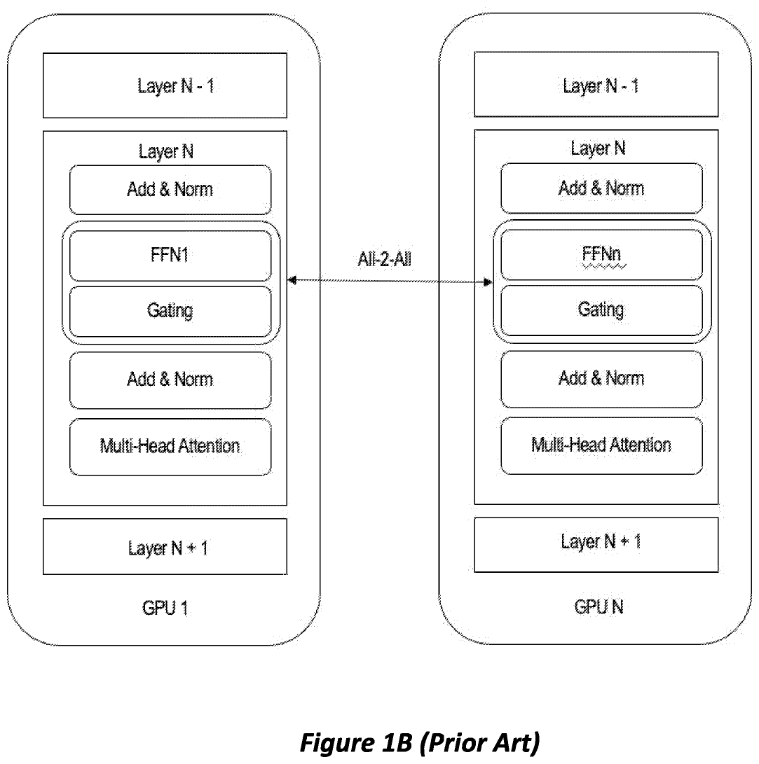

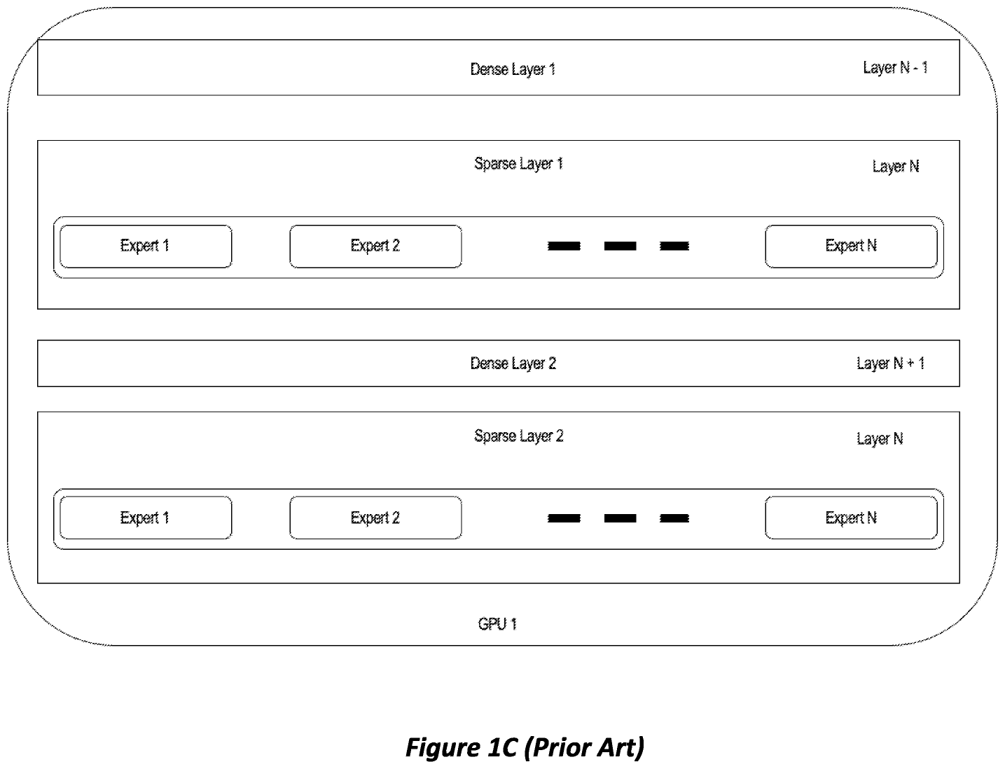

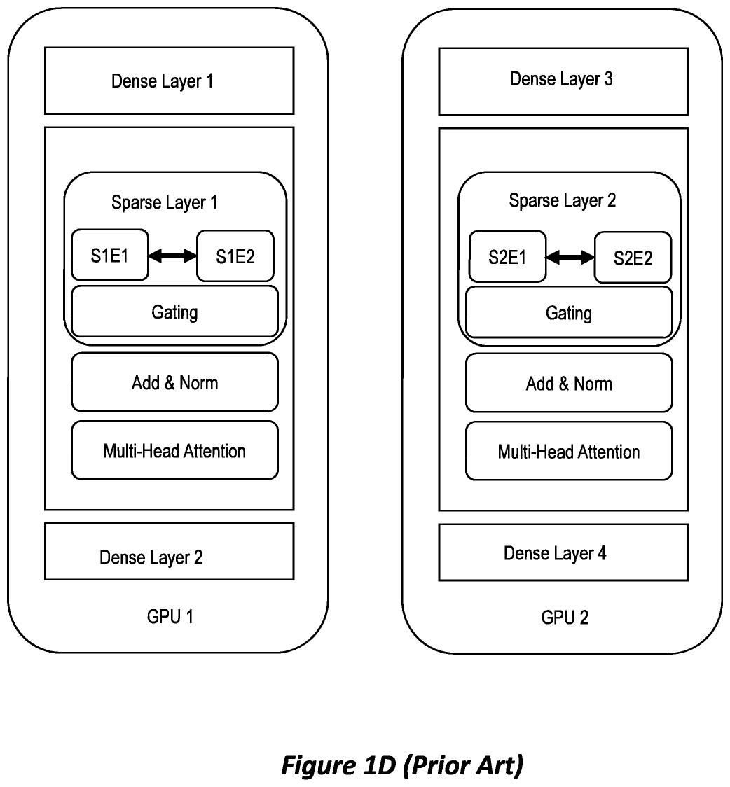

This is in contrast to dense layers where all or most neurons participate in the data processing, instead of a select few as is the case for sparse layers. In some existing systems, the entire machine learning model including dense and sparse layers is distributed onto a single piece of hardware, referred to herein as an accelerator (e.g., GPU 1), as illustrated in FIG. 1A. For example, as illustrated, GPU 1 comprises a plurality of layers (e.g., Layer N−1, Layer N, and Layer N+1). Layer N further comprises an Add & Norm layer, one or more experts on feed-forward network layers (e.g., FFN1, FFN2, FFNe, etc.), a gating layer, an additional Add & Norm layer, as well as a multi-head attention layer. In this manner, Layer N−1 and Layer N+1 are dense layers, while the sparse layer within Layer N comprises the different experts.

With regard to the foregoing, and the rest of this disclosure, there are several references made to the term accelerator. Such accelerators, which are part of a computing system, are hardware devices or processing units (i.e., microprocessors), that comprise memory and processing capabilities that augment the performance of the computing system. These components are referred to as accelerators, in some instances, because they can increase the speed at which a computing system is able to process data and perform the various functions for which it is programmed. By utilizing accelerators, for example, computing systems are enabled to perform parallel processing with other processing units, such as the CPU, in the computing system.
it will be appreciated that there are many different types of accelerators, including but not limited to, a hardware accelerator, a multi-core central processing unit (CPU), a graphics accelerator (e.g., a graphics processing unit (GPU)), a cryptographic accelerator, a web accelerator, a PHP accelerator, or another type of accelerator, all of which are collectively referred to herein as accelerators, and each of which comprises one or more dense or sparse layers of a corresponding machine learning model.

It will also be noted that the term MOE model, MOE machine learning model, MOE machine learning model instance, and model are all used interchangeably at times throughout this disclosure. Each of the terms generally refers to a MOE-based transformer machine learning model architecture and corresponding specific instance of the model in which the model has been structured with components for processing data (e.g., tokens) with the different layers of the model for determining probabilities and/or for generating output predictions or determinations based on inputs and probabilities of the outputs corresponding to the inputs, wherein the probabilities are determined by algorithms, weights, and attention applied at each of the different layers.

The different layers of an MOE-based transformer machine learning model are configurable in a variety of configurations. In some existing systems, the different layers of the machine learning model are distributed onto a plurality of accelerators (e.g., GPU 1 and GPU N), wherein each accelerator has a single expert in its sparse layer, as illustrated in FIG. 1B. For example, while each of GPU 1 and GPU N has similar layer configurations as GPU 1 in FIG. 1A, both GPU 1 and GPU N each only comprise a single expert (e.g., FFN1 in GPU 1 and FFNn in GPU N) within its sparse layer, Layer N.

In some configurations, the dense layers and sparse layers are interleaved. For example, if a machine learning model is constructed using two dense layers (e.g., Dense Layer 1, Dense Layer 2) and two sparse layers (e.g., Sparse Layer 1, Sparse Layer 2), the machine learning model can be configured according to FIG. 1C. As illustrated, input data is processed first by Dense Layer 1, then by Sparse Layer 1, then Dense Layer 2, then Sparse Layer 2, in order to generate the final output.

In FIG. 1D, each sparse layer is made up of at least two experts. For example, Sparse Layer 1 comprises a first plurality of experts (e.g., S1E1, S1E2) and Sparse Layer 2 comprises a second plurality of experts (e.g., S2E1, S2E2). In order to accommodate such a large machine learning model (i.e., the entire model will not fit onto a single accelerator), the layers of the machine learning model are distributed onto more than one accelerator. For example, Dense Layer 1, Sparse layer 1, and Dense Layer 2 are distributed on GPU1, while Dense Layer 3, Sparse Layer 2, and Dense Layer 4 are distributed on GPU2. This distribution scheme for distributing or configuring the model layers and experts on the accelerators is referred to as Model Parallelism. Model Parallelism is highly inefficient because while GPU1 is processing an input, GPU2 remains idle, and while GPU2 is processing an input, GPU1 is idle.

Some work has focused on mitigating this inefficiency by introducing a processing pipeline, such that when GPU2 is processing the first input (after the first input has been processed by GPU1), GPU1 starts processing a second input. However, this configuration still has drawbacks in that the GPU utilization remains low because any experts in the one or more sparse layers that are not participating in processing a given input still occupy significant GPU memory.

An additional improvement has been explored, referred to as Expert Parallelism which provides for a model configuration where experts are evenly distributed across GPUs. In such configurations, the system can process up to N inputs simultaneously based on N number of GPUs. In one example, where there are four GPUs and four experts, each GPU allocates for only a single expert from each sparse layer. In this configuration, the system can process up to four inputs simultaneously.

The sparse layers will exchange inputs such that each input is sent to the GPU where the expert which has been selected to process the input is stored. However, even this improvement still experiences limited capabilities. For example, each GPU processes dense layers, in addition to sparse layers. In some instances, this is inefficient because large amounts of memory are taken up by the sparse layers, which do require less processing than dense layers. This decreases the overall computational efficiency of the system. Additionally, or alternatively, the model on each GPU consumes the same amount of memory and computation resources. Thus, scalability is bound by the GPU with the least computation power and memory, which results in inefficiencies in GPUs in the system that have larger memory storage and/or computational power.

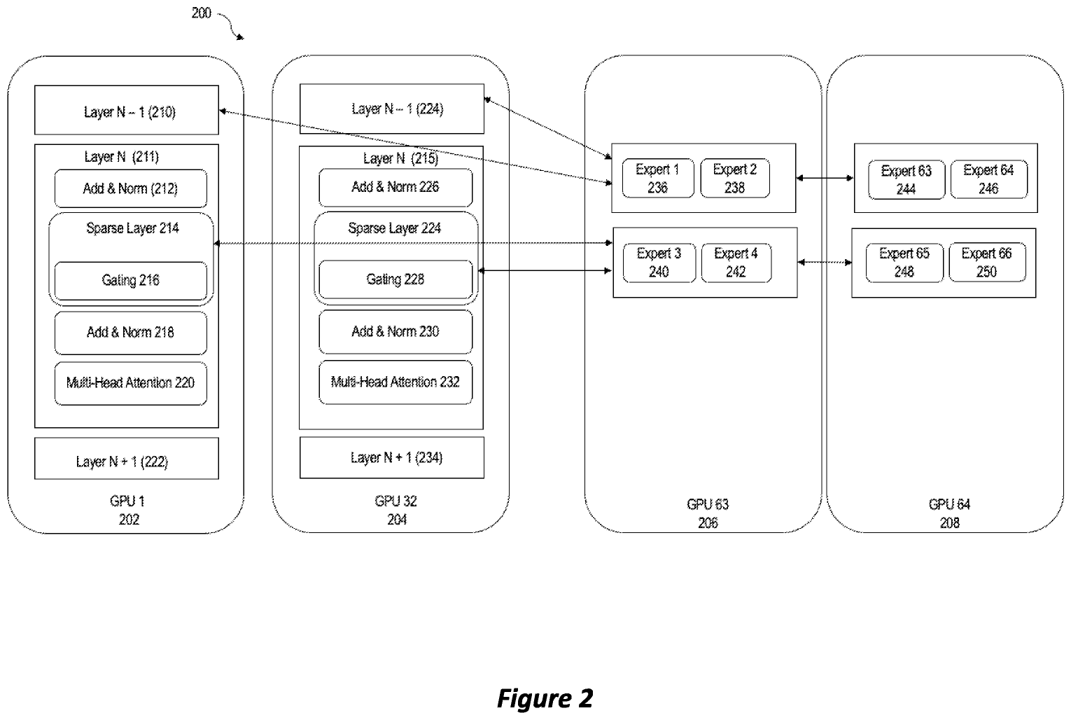

Attention will be directed to FIG. 2, which illustrates an example embodiment of a special expert machine learning model, wherein sparse layers are distributed onto sparse hardware and dense layers are distributed onto dense hardware, and wherein sparse layers are interleaved with the dense layers such that the sparse hardware can process multiple outputs from multiple dense hardware devices.

For example, computing system 200 is shown to have a plurality of accelerators (e.g., accelerator 202, accelerator 204, accelerator 206, accelerator 208, and one or more other accelerators not illustrated). A machine learning model is distributed onto the various accelerators. For example, a first plurality of model layers (e.g., layer 210, layer 211, and layer 222) are shown distributed onto accelerator 202. Each layer further comprises one or more layers (i.e., sub-layers). For example, layer 211 comprises layer 212 (e.g., Add & Norm), layer 214 (e.g., Sparse Layer) which further includes a gating layer 216, layer 218 (e.g., Add & Norm), and layer 220 (e.g., Multi-Head Attention).

Similarly, a second plurality of model layers (e.g., layer 224, layer 215, and layer 234) are shown distributed onto accelerator 204. Each layer further comprises one or more layers (i.e., sub-layers). For example, layer 215 comprises layer 226 (e.g., Add & Norm), layer 224 (e.g., Sparse Layer) which further includes a gating layer 228, layer 230 (e.g., Add & Norm), and layer 232 (e.g., Multi-Head Attention).

As illustrated in FIG. 2, the experts from the different sparse layers have been distributed onto separate accelerators. For example, expert 236 and expert 238 from a sparse layer associated with layer 210 and expert 240 and expert 242 from layer 214 associated with layer 211 are distributed onto accelerator 206. Additionally, expert 244, expert 246, expert 248, and expert 250 are distributed onto accelerator 208. As shown, the experts are configured to receive different inputs from various layers of the machine learning model as distributed across multiple accelerators. This prevents certain components from being idle while other components are actively processing data.

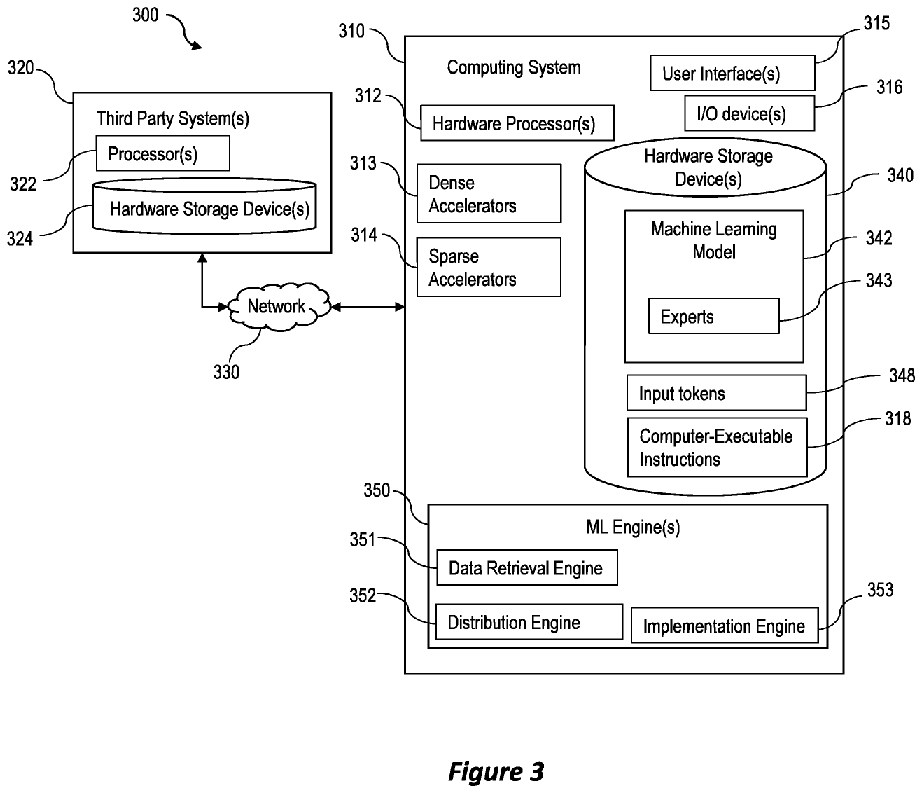

Attention will now be directed to FIG. 3, which illustrates components of a computing system 310 which may include and/or be used to implement aspects of the disclosed invention. As shown, the computing system includes a plurality of machine learning (ML) engines, models, and data types associated with inputs and outputs of the machine learning engines and models. For example, FIG. 3 illustrates the computing system 310 as part of a computing environment 300 that also includes remote/third party system(s) 320 in communication (via a network 330) with the computing system 310. The computing system is in communication with remote/third-party system(s) 320 comprising one or more processor(s) 322 and one or more computer-executable instruction(s) 324. It is anticipated that, in some instances, the remote/third party system(s) 320 further comprise databases housing data that could be used as training data, for example, external speaker data. Additionally, or alternatively, the remote/third-party system(s) 320 include machine learning systems external to the computing system 310. In some embodiments, the remote/third-party system(s) 320 are software programs or applications.

The computing system 310, for example, includes one or more processor(s) 312 (such as one or more hardware processor(s)) and a storage (i.e., hardware storage device(s) 340) storing computer-executable instructions 318. One or more of the hardware storage device(s) 340 is able to store any number of data types and any number of computer-executable instructions 318 by which the computing system 310 is configured to implement one or more aspects of the disclosed embodiments when the computer-executable instructions 318 are executed by the one or more processor(s) 312.

The computing system 310 further comprises a plurality of accelerators (e.g., dense accelerators 313 and sparse accelerators 314). In some configurations, dense accelerators 313 are configured to process input data using dense layers, wherein the dense accelerators 313 are customized hardware optimized for processing power. In such configurations, the sparse accelerators 314 are configured to process input data using sparse layers, wherein the sparse accelerators 314 are customized hardware optimized for memory storage. The sparse accelerators 314 are more efficient in processing sparse data (e.g., sparse tensors, sparse layers) than dense accelerators. Each of the accelerators can comprise a specialized processor or other hardware capable of storing and/or executing the corresponding dense and sparse layers (344 and 346, respectively).

In some instances, the sparse accelerators have at least a 10% greater memory or storage capacity than the dense accelerators, or even more than that (e.g., 20%, 30%, 40%, 50%, 60%, 70%, 80%, 90% or even more than 100% greater memory storage capacity than the dense accelerators). Additionally, or alternatively, the sparse accelerators are at least 10% more efficient than dense accelerators in processing sparse data, or even more than that (e.g., 20%, 30%, 40%, 50%, 60%, 70%, 80%, 90% or even more than 100% more efficient than the dense accelerators in processing sparse data).

In some instances, the dense accelerators have at least a 10% greater processing capability than the sparse accelerators, or even more than that (e.g., 20%, 30%, 40%, 50%, 60%, 70%, 80%, 90% or even more than 100% greater processing capability the sparse accelerators). For example, the dense accelerators are more efficient in processing dense data (e.g., dense layers, dense tensors) than sparse accelerators.

In some instances, sparse accelerators are distinguished from dense accelerators based at least on their greater efficiency in processing sparse data. Additionally, or alternatively, sparse accelerators are distinguished from dense accelerators based on their increased memory capacity and/or reduced number of raw FLOPs as compared to dense accelerators. The computing system 310 is also shown including user interface(s) 315 and input/output (I/O) device(s) 316.

As shown in FIG. 3, hardware storage device(s) 340 is shown as a single storage unit. However, it will be appreciated that the hardware storage device(s) 340 is, in some embodiments, a distributed storage that is distributed to several separate and sometimes remote and/or third-party system(s) 320 (e.g., hardware storage devices 324). The computing system 310 can also comprise a distributed system, in some embodiments, with one or more of the components of computing system 310 being maintained/run by different discrete systems that are remote from each other and that each performs different tasks. In some instances, a plurality of distributed systems performs similar and/or shared tasks for implementing the disclosed functionality, such as in a distributed cloud environment.

In this manner, different layers of the machine learning model are distributable onto computing system 310 and/or across a distributed computing system 300 including computing system 310 and one or more third-party system(s) 320. The hardware storage device(s) 340 are configured to store the different data (e.g., input tokens 348) including various models such as machine learning model 342 which comprises a plurality of experts (e.g., experts 343).

The storage (e.g., hardware storage device(s) 340) includes computer-executable instructions 318 for instantiating or executing one or more of the models and/or engines shown in computing system 310. The models are configured as machine-learning models or machine-learned models, such as deep-learning models and/or algorithms. In some instances, the one or more models are configured as engines or processing systems (e.g., computing systems integrated within computing system 310), wherein each engine (i.e., model) comprises one or more processors (e.g., hardware processor(s) 312) and computer-executable instructions 318 corresponding to the computing system 310.

An additional storage unit for storing machine learning (ML) Engine(s) 350 is presently shown in FIG. 3 as storing a plurality of machine learning models and/or engines. For example, computing system 310 comprises one or more of the following: a data retrieval engine 351, a distribution engine 352, and an implementation engine 353, which are individually and/or collectively configured to implement the different functions described herein.

For example, the data retrieval engine 351 is configured to locate and access data sources, databases, and/or storage devices comprising one or more data types from which the data retrieval engine 351 can extract sets or subsets of data to be used as input data. The data retrieval engine 351 receives data from the databases and/or hardware storage devices, wherein the data retrieval engine 351 is configured to reformat or otherwise augment the received data to be used as training data or input data. Additionally, or alternatively, the data retrieval engine 351 is in communication with one or more remote/third-party systems (e.g., remote/third-party system(s) 320) comprising remote/third-party datasets and/or data sources. In some instances, these data sources comprise audiovisual services that record speech, text, images, and/or video.

The data retrieval engine 351 accesses electronic content comprising acoustic data, textual data, and/or other types of audio-visual data including video data, image data, holographic data, 3-D image data, etc. The data retrieval engine 351 is a smart engine that is able to learn optimal dataset extraction processes to provide a sufficient amount of data in a timely manner as well as retrieve data that is most applicable to the desired applications for which the machine learning models/engines will be used. For example, the data retrieval engine 351 can learn which databases and/or datasets will generate training data that will train a model (e.g., for a specific query or specific task) to increase the accuracy, efficiency, and efficacy of that model in the desired layer distribution configuration.

In some embodiments, the computing system 310 comprises a distribution engine 352 which is configured to determine a distribution of the different layers of the machine learning model 342 across the different accelerators. The distribution engine 352 is also configured to apply the distribution prior to an instantiation of the model or re-distribution of the machine learning model after an instantiation of the model. In some instances, the re-distribution is based on identifying a potential improvement in one or more attributes of the computing system (e.g., model throughput, computing efficiency) and/or based on scaling up or down of the machine learning model. In some embodiments, the re-distribution is implemented by migrating one or more experts from one accelerator to a different accelerator.

The distribution engine 352 is configured to dynamically identify the total number of accelerators that make up the computing system 310, as well as identify which accelerators are specialized or optimized hardware devices for dense layers versus sparse layers. Additionally, the distribution engine 352 is configured to identify which accelerators are full (i.e., accelerators that do not have storage capacity to store another expert) and/or which accelerators have available or anticipated processing capacity and/or memory space for storing and executing the one or more additional experts.

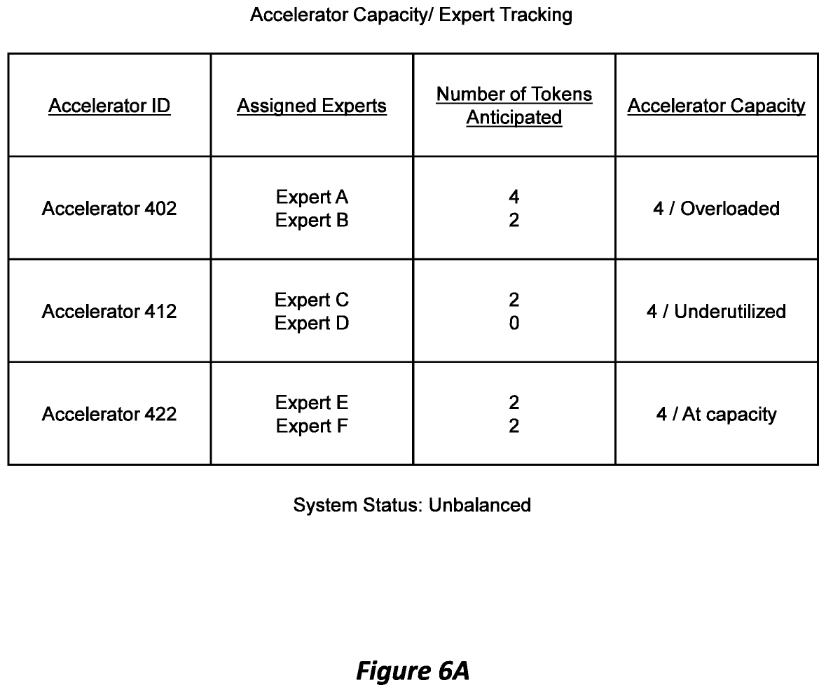

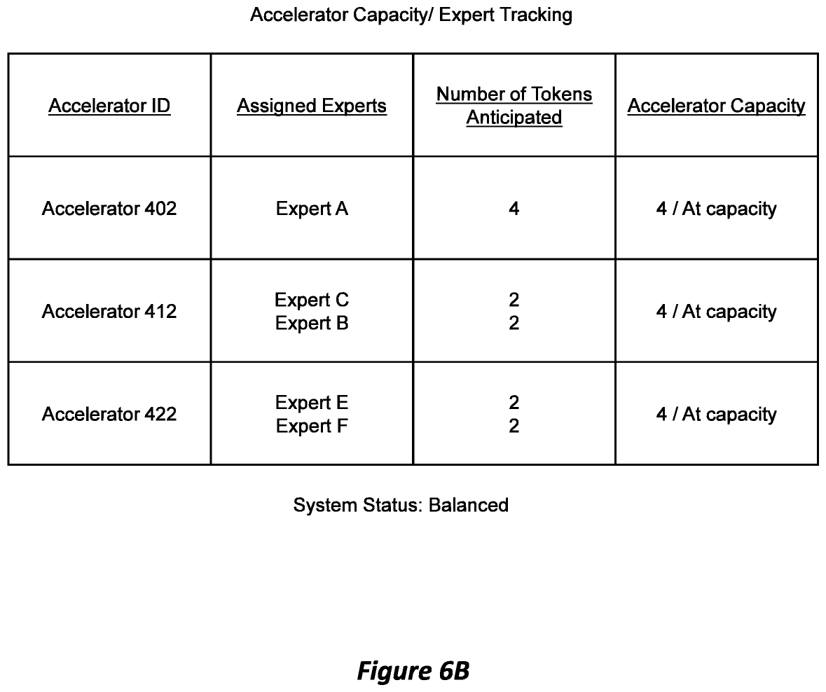

The distribution engine 352 is also configured to identify accelerators that are underutilized, at capacity, or overloaded, terms that refer to an accelerator's ability to process input tokens. An underutilized accelerator (e.g., accelerator 412 of FIG. 6A) is an accelerator that stores a set of experts that are assigned to collectively process a lesser number of inputs than the accelerator has the capacity to process, meaning that the accelerator may be able to store an additional expert and/or a different expert assigned to process more tokens than a current expert. An accelerator that is at capacity (e.g., accelerator 422 of FIG. 6A) is an accelerator that stores a set of experts that are assigned to collectively process an exact number of tokens that the accelerator is configured to process. An overloaded accelerator is an accelerator that stores a set of experts that are assigned to collectively process a greater number of inputs than the accelerator is able to process. For example, in FIG. 6A, accelerator 402 has an accelerator capacity for processing a maximum of 4 tokens. However, Expert A (which is assigned to process 4 tokens) and Expert B (which is assigned to process 2 tokens) are both currently stored on accelerator 402. This means that accelerator 402 is assigned to process 6 tokens in total based on the stored set of experts, meaning that accelerator 402 is overloaded and will likely drop one or more tokens during processing.

The distribution engine 352 is also configured to identify how many layers make up the machine learning model, as well as identify which layers are dense layers and which layers are sparse layers. The distribution engine 352 is further configured to identify how many experts are in each of the different sparse layers, as well as identify attributes of the experts (e.g., what specialized task is associated with an expert).

Thus, based on the number of dense layers and number of sparse layers (or number of experts across one or more sparse layers), the distribution engine 352 is configured to dynamically and automatically distribute the different layers or different experts onto one or more accelerators of the computing system 310. The distribution engine 352 is configured, in some instances, to distribute dense layers 344 onto dense accelerators 313 (e.g., accelerators determined to have capabilities for storing and/or executing the dense layers) and sparse layers 346 onto sparse accelerators 314 (e.g., accelerators that have more limited capacity and capabilities than the dense accelerators). The distribution engine 352 can also distribute or re-distribute different shards of the experts onto different accelerators.

In some instances, the distribution engine 342 is also configured to separate sparse layers (that comprise one or more experts) from dense layers and then distribute sparse layers onto accelerators configured for storing/processing sparse layers (e.g., accelerators having greater processing capability than other accelerators) and distribute dense layers onto accelerators configured for storing/processing dense layers (e.g., accelerators having greater memory capability than other accelerators). In this manner, sparse layers and dense layers are segregated into separate groups and each group is assigned its own set of accelerators. By distributing the machine learning model according to this configuration, computing systems are able to achieve the following technical advantages. First, the system is able to apply specific performance optimizations that are suitable for dense computations and sparse computations in a selective manner. Additionally, MOE layers, such as sparse layers that comprise one or more experts, incorporate heavy communication overheads. Thus, configurations which distribute sparse layers and dense layers onto separate accelerators enable the system to exploit higher communication bandwidth available within a subset of the cluster (e.g., on a single node or nodes in a single rack).

Furthermore, by distributing a machine learning model in this manner, a single set of MOE layers can be scheduled to process multiple interleaving inputs to increase the model throughput (either for training, inference, and/or implementation) efficiently. The disclosed embodiments are also directed to systems and methods which are capable of using heterogynous clusters to reduce computational cost and improve the performance of the computing system/machine learning model. In particular, such configurations facilitate a significant reduction in time necessary for training the machine learning, thus allowing users to deploy the machine learning model into implementation tasks more quickly.

In some embodiments, the computing system 310 includes an implementation engine 353 in communication with any one of the models and/or ML engine(s) 350 (or all of the models/engines) included in the computing system 310 such that the implementation engine 353 is configured to implement, initiate, or run one or more functions of the plurality of ML engine(s) 350. In one example, the implementation engine 353 is configured to operate the data retrieval engine 351 so that the data retrieval engine 351 retrieves data at the appropriate time to be able to process input tokens 348. The implementation engine 353 facilitates the process communication and timing of communication between one or more of the ML engine(s) 350.

In another example, the implementation engine 353 is configured to implement one or more functionalities (i.e., processing input tokens 348) of the machine learning model 342 as distributed onto computing system 310 or across computing system 310 and third-party system(s) 320. The implementation engine 353 also is configured to implement the distribution engine 352 in order to identify a distribution or a re-distribution of the different layers of the machine learning model.

Furthermore, the implementation engine 353 is configured to select which experts distributed on the various accelerators will be used in processing the input tokens 348. By implementing the systems and methods according to these disclosed embodiments, the computing system 310 is able to achieve technical benefits, such as being customizable and scalable. In particular, different experts can be used at different times in processing the input tokens 348. Thus, the system can be configured to select a limited number of experts to use in processing the input data based on the type of input data, formatting of input data, context of the input data, and/or downstream applications of the processed input data.

When one or more experts are identified as the experts that will be used in processing the input data, the system can distribute or re-distribute one or more sparse layers comprising those identified experts onto different accelerators in order to increase the model throughput and increase the computational efficiency of the system. Additionally, the system can distribute or re-distribute one or more particular experts on the accelerators to also achieve an increase in the computational efficiency of the system.

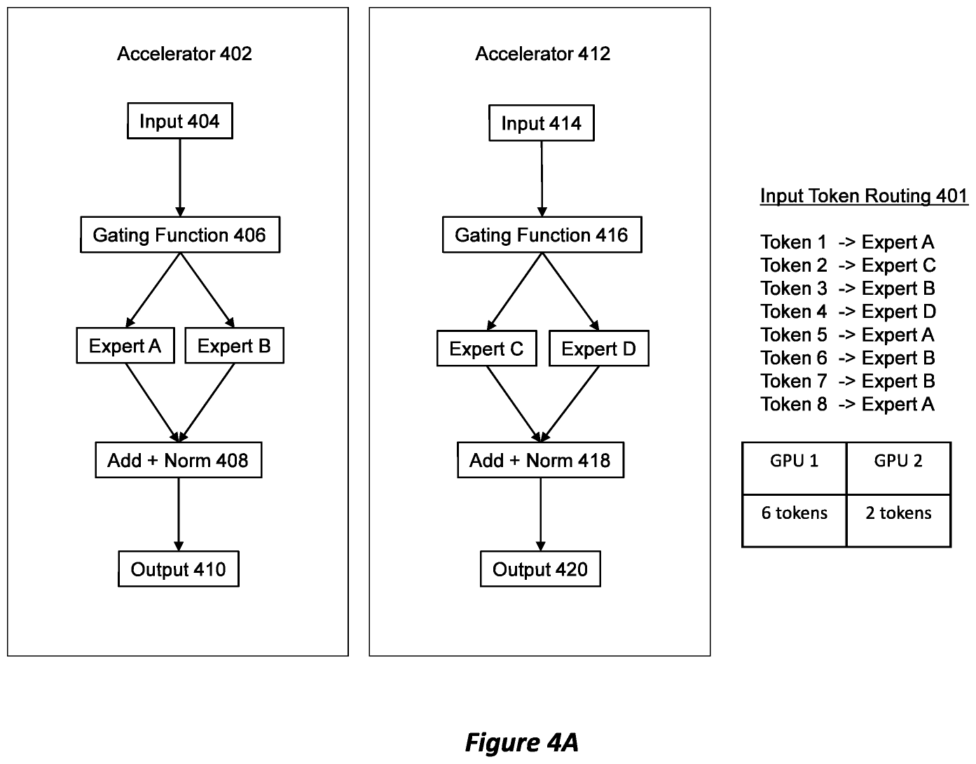

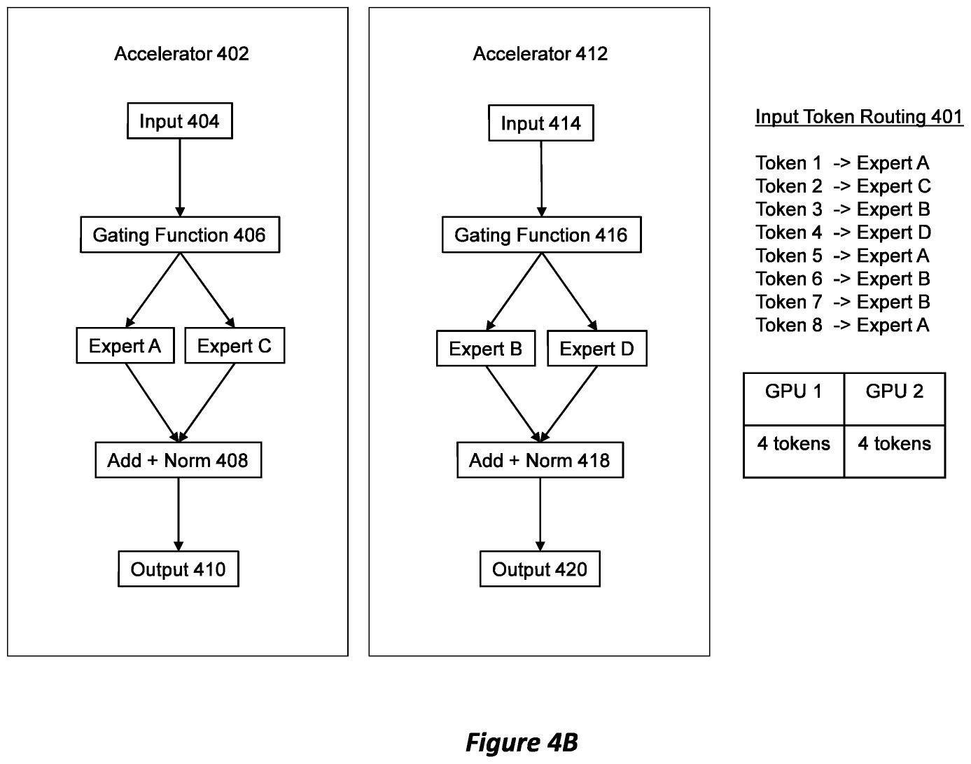

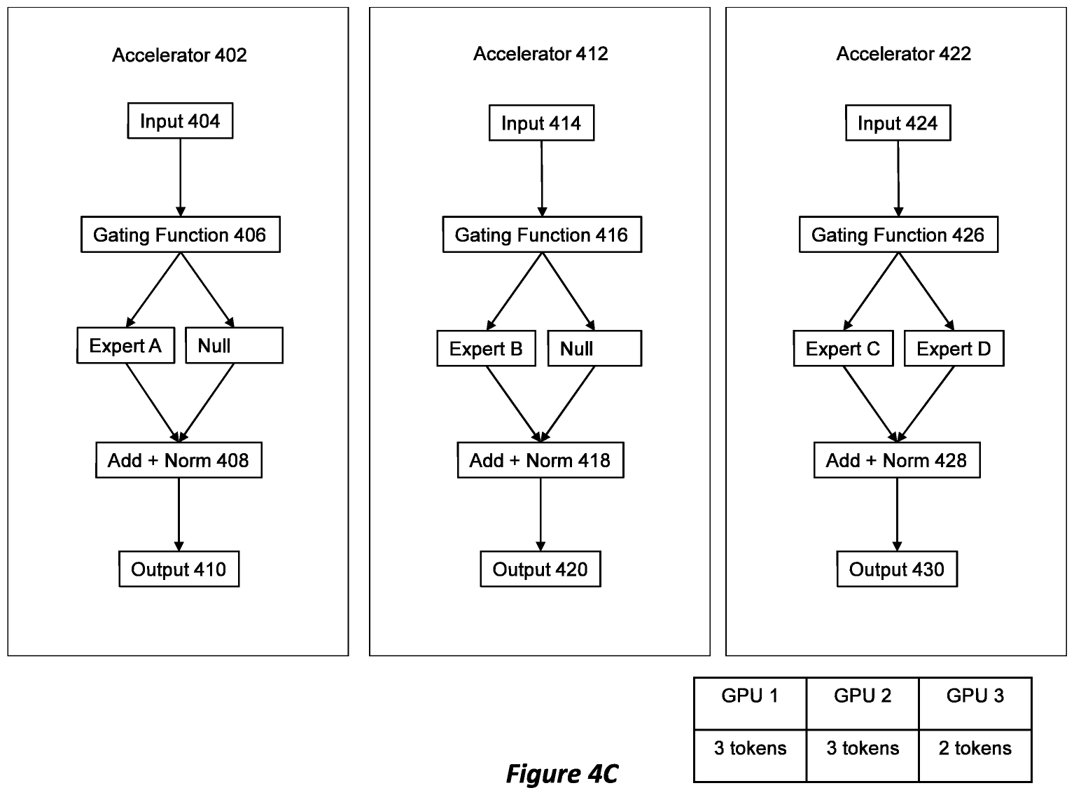

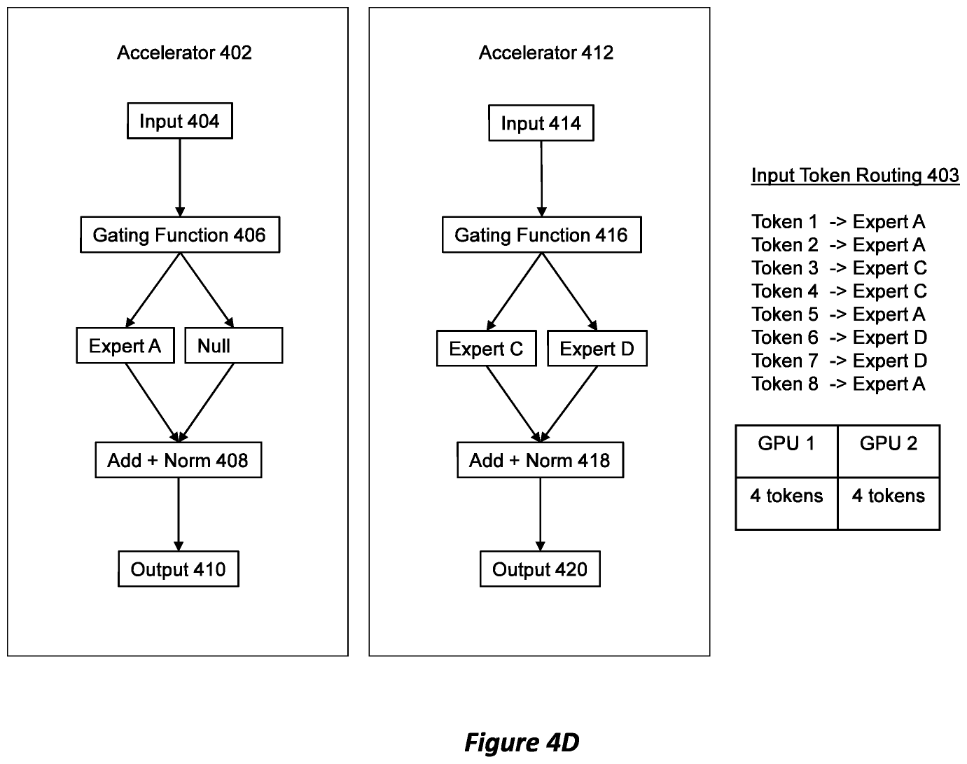

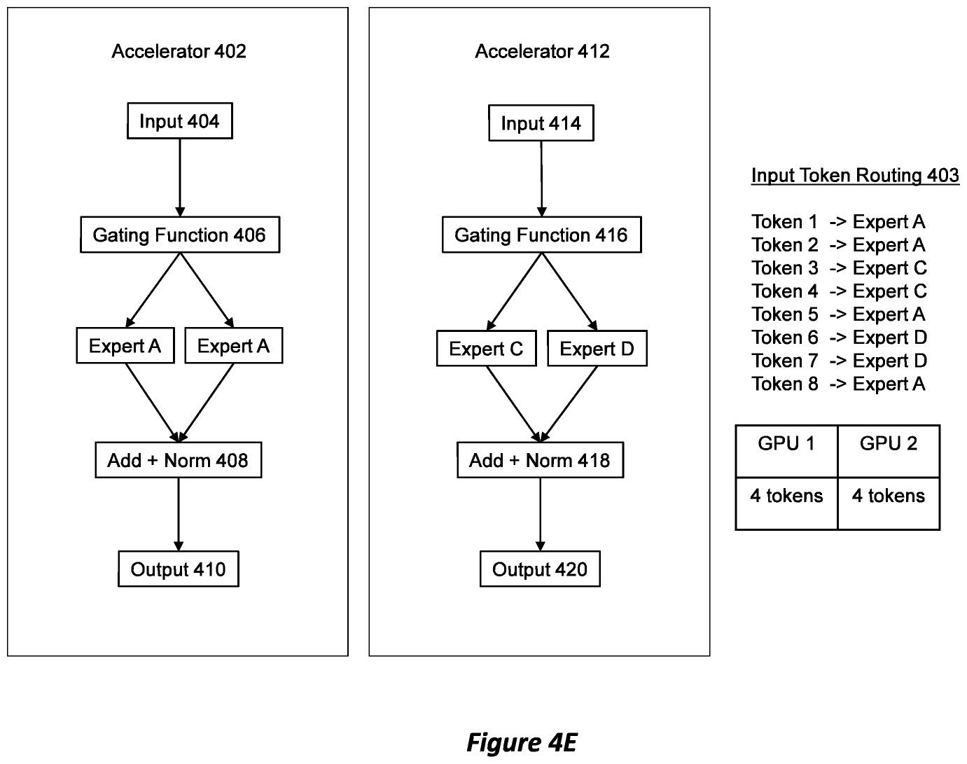

Attention will now be directed to FIGS. 4A-4E, which illustrate various embodiments of distributing and redistributing a machine learning model (e.g., a mixture of experts) on different accelerators of a computing system (e.g., computing system 310). It should be appreciated that the following systems and methods related to redistributing experts (e.g., self-balancing of experts) to achieve improvement in the processing efficiency achieve further improvements over systems and methods illustrated in FIG. 2.

Attention will first be directed to FIG. 4A, which illustrates an initial distribution of experts on multiple accelerators. For example, accelerator 402 comprises a gating function 406 which receives input 404 (e.g., one or more input tokens), Expert A, Expert B, and an additional and normalization layer (e.g., Add+Norm 408) which generates output 410. The gating functions serve to dynamically or according to a predetermined routing, route the input tokens to the respective experts located on the accelerators. Accelerator 412 comprises a gating function 414 which receives input 414, Expert C, Expert D, and Add+Norm 418 which generates output 420.

In some instances, each token is pre-assigned to a particular expert, as indicated by the routing assignment (e.g., Input Token Routing 401). As shown in FIG. 4A, Token 1 will be routed to Expert A, Token 2 will be routed to Expert C, Token 3 will be routed to Expert B, Token 4 will be routed to Expert D, Token 5 will be routed to Expert A, Token 6 will be routed to Expert B, Token 7 will be routed to Expert B, and Token 8 will be routed to Expert A. In this case, three tokens will be processed by Expert A, three tokens will be processed by Expert B, one token will be processed by Expert C, and one token will be processed by Expert D. Because Expert A and Expert B are currently distributed on accelerator 402 (e.g., GPU 1), accelerator 402 will be processing six tokens according to the routing assignments, namely, the input token routing assignments. Because Expert C and Expert D are currently distributed on accelerator 412 (e.g., GPU 2), accelerator 412 will be processing two tokens according to the input token routing assignments. Thus, accelerator 402 will be processing more tokens than accelerator 412, even though both accelerators have the same number of experts.

In some instances, this causes an imbalance in the processing of input by the machine learning model as currently distributed on the computing system. For example, accelerator 402 may become overloaded by the greater number of tokens versus accelerator 412, which is underutilized. Thus, the disclosed embodiments are directed to systems and methods which improve the processing efficiency of the computing system and/or improve the balance of processing tokens across multiple accelerators by redistributing the experts among the available accelerators.

Attention will now be directed to FIG. 4B, which illustrates a redistribution of experts on the different accelerators, with the same input token routing as indicated in FIG. 4A. For example, Expert B and Expert C have been swapped, such that (i) accelerator 402 now stores Expert A and Expert C and (ii) accelerator 412 stores Expert B and Expert D. Thus, accelerator 402 now processes four tokens and accelerator 412 also processes four tokens.

This improves the processing efficiency of the computing system because both accelerators are now being utilized equally. This also improves the processing efficiency because output 410 and output 420 will be generated at approximately the same time, or at more similar times, because both accelerators are processing the same number of tokens. This also reduces computational time because if a subsequent layer of the machine learning model needs both output 410 and output 420 before being able to generate subsequent output, that subsequent layer will not have to wait for accelerator 402 to finish processing more tokens, as it would in FIG. 4A.

Attention will now be directed to FIG. 4C, which illustrates an alternate redistribution of experts on multiple accelerators. In some instances, to improve the processing efficiency of the computing system, one or more experts may be relocated (e.g., wherein experts are moved from being stored on one accelerator to being stored on a different accelerator) to a new available accelerator, instead of interchanged (i.e., exchanged, swapped) between current accelerators as shown in FIG. 4B. In such instances, the computing system is able to identify other accelerators which are able to store one or more experts. As shown in FIG. 4C, accelerator 422 was identified as an additional accelerator that could be used for expert distribution, in addition to accelerator 402 and accelerator 412. In some instances, the computing system initiates a search for an additional accelerator and/or initiates a relocation of one or more experts to a different accelerator if the system determines that the accelerator which initially stored the expert(s) would be processing over its capacity (e.g., it would be overloaded, is currently being overloaded, or was overloaded by the input tokens).

As shown in FIG. 4C, accelerator 422 includes a gating function 426 which receives input 424, experts that have been relocated from other accelerators, and Add+Norm 428 which generates output 430. For example, Expert C has been relocated to accelerator 422 from accelerator 402—which now has a null space (i.e., empty space or memory storage available for an expert) and Expert D has been relocated to accelerator 422 from accelerator 412 (which also now has a null space).

In this new distribution (or redistribution) of experts with the same token input routing as FIG. 4A, accelerator 402 (e.g., GPU 1) processes three tokens, accelerator 412 (e.g., GPU 2) processes three tokens, and accelerator 422 (e.g., GPU 3) processes two tokens. Thus, the number of tokens processed by accelerator 402 and accelerator 412 have been reduced by this redistribution, as compared to either the initial distribution in FIG. 4A, or the redistribution of FIG. 4B, by utilizing an additional accelerator. This in turn improves the processing efficiency of the computing system and reduces the computational time of processing the input tokens, because accelerator 402, accelerator 412, and accelerator 422 can process tokens simultaneously.

Attention will now be directed to FIG. 4D, which illustrates an alternate embodiment of a redistribution of experts on multiple accelerators according to an input token routing 403, which is a new input token routing. In the new input token routing, Token 1 is assigned to Expert A, Token 2 is assigned to Expert A, Token 3 is assigned to Expert C, Token 4 is assigned to Expert C, Token 5 is assigned to Expert A, Token 6 is assigned to Expert D, Token 7 is assigned to Expert D, and Token 8 is assigned to Token 8. Thus, Expert A will process four tokens, Expert B will process zero tokens, Expert C will process two tokens, and Expert D will process two tokens.

Based on the new input token routing, if accelerator 402 initially stored Expert A and Expert B and accelerator 412 initially stored Expert C and Expert D (e.g., see FIG. 4A), accelerator 402 would process four tokens, and accelerator 412 would process four tokens. However, the computing system is able to identify a redistribution that improves the processing efficiency of the computing system and reduces the size of the machine learning model. For example, as shown in FIG. 4D, the computing system determines that Expert B will not be used to process any tokens from the input token set associated with input token routing 403. Thus, Expert B is removed from accelerator 402, which now has a null space. In some instances, Expert B can be cached in a holding storage memory until it is needed again to process input tokens.

Attention will now be directed to FIG. 4E, which illustrates another example embodiment of a redistribution of experts on multiple accelerators. For example, when an accelerator has one or more null spaces (i.e., it has the available capacity to store one or more experts), a new expert can be stored in that location on the accelerator or relocated to that location from a different accelerator.

Additionally, or alternatively, a particular expert that has a high number of tokens to process, can be duplicated, so that multiple of the same experts can process assigned tokens in parallel. As shown in FIG. 402, a duplicate of Expert A is stored on accelerator 402, such that accelerator 402 now has two of the same experts (i.e., two of Expert A). Thus, while accelerator 402 still processes four tokens and accelerator 412 still processes four tokens according to input token routing 403, accelerator 402 will be able to process the tokens assigned to Expert A faster than the initial distribution of experts shown in either FIG. 4A or FIG. 4D, because two of Expert A are able to process the assigned tokens in parallel. This improves the processing efficiency of the computing system and reduces computational time, in particular by facilitating parallel processing of tokens assigned to the same expert.

It should be noted that during model training, systems are also configured, in some instances, to sync the two copies of Expert A after processing input tokens. Each expert's weights are updated as part of processing an input token during training. Thus, syncing the duplicate experts ensures that the updated weights are still duplicates of each other, even if processing input tokens modifies one or more of the weights of either expert.

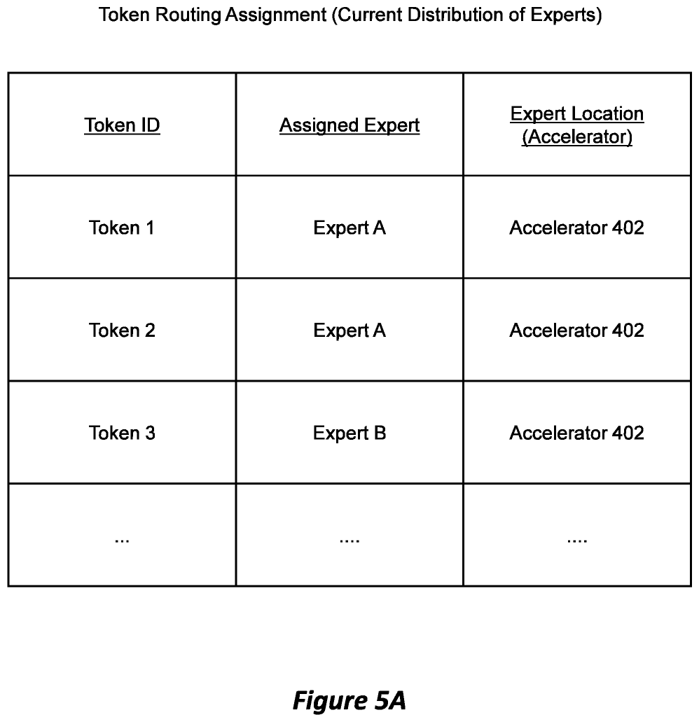

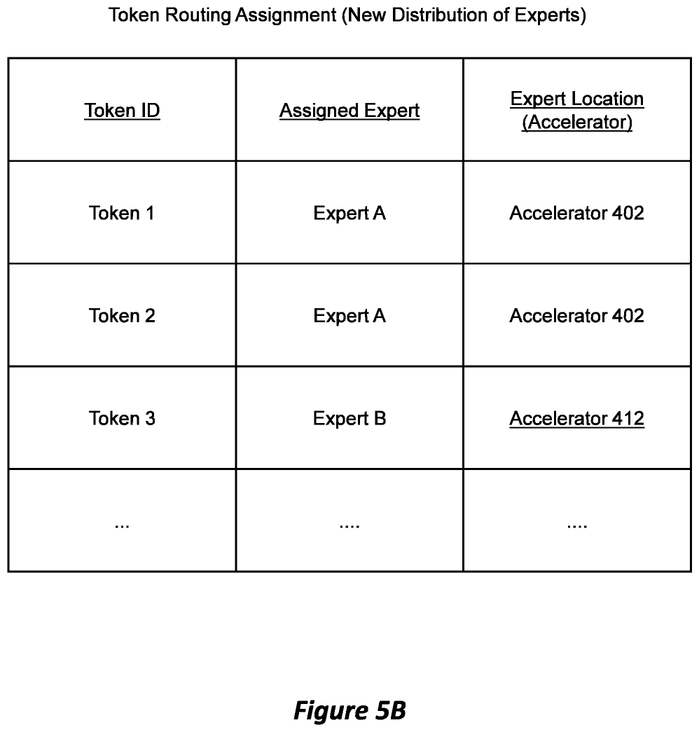

Attention will now be directed to FIGS. 5A-5B, which illustrate a current and new distribution of experts. Because the computing system can implement a redistribution of experts prior to input token processing, during the run-time of input token processing, or after an initial input token processing, it is beneficial to keep track of which tokens are assigned to which experts, and which accelerators store which experts.

The computing system is beneficially configured to track tokens, experts, and accelerators. For example, as shown in FIG. 5A, under a current or initial distribution of experts, Token 1 is assigned to Expert A which is stored on accelerator 402; Token 2 is assigned to Expert A stored on accelerator 402; Token 3 is assigned to Expert B which is also stored on accelerator 402, and so on. After the computing system determines that a new distribution will result in an improvement in the processing efficiency of the computing system, the system will redistribute the experts according to the new distribution. For example, FIG. 5B shows that while Token 3 is still assigned to Expert B, Expert B has been relocated to Accelerator 412.

In some instances, as shown in FIG. 5B, a user interface displays a token routing assignment chart, with a visual indication or formatting (e.g., underlining, bolding, change in font color, etc.) that indicates if an expert location has been changed (e.g., “Accelerator 412”). Some of the disclosed embodiments include the use of data structures like tracking charts, tables, or other data structures for managing routing assignments. FIGS. 5A-5B, for example, illustrate token routing assignment charts that can be used to track the current and correct status of the accelerator locations. Similar charts with modified data fields can also be used for tracking the current and/or historical loads and/or anticipated loads for the different accelerators and experts. This beneficially allows users a convenient way to visually inspect the current and any subsequent new distributions of token assignments and expert locations and anticipated utilizations/loads of the different experts and accelerators.

Attention will now be directed to FIGS. 6A-6B, which illustrate an unbalanced and a subsequent balanced system in terms of accelerator capacity and expert tracking. In particular, FIG. 6A shows a current distribution of experts on multiple accelerators, the resulting number of tokens anticipated to be processed by the accelerator, and an analysis of the accelerators' capacity vs. the number of tokens. For example, accelerator 402 stores Expert A and Expert B, resulting in six total tokens anticipated to be processed.

In this case, because the accelerator processing capacity is four tokens, the system determines that accelerator 402 is overloaded. Accelerator 412 stores Expert C and Expert D initially and is anticipated to process a total of two tokens. Thus, accelerator 412 is determined to be underutilized. Accelerator 422 is shown to house Expert E and Expert F, each processing two tokens, for a total of four tokens to be processed by accelerator 422. The capacity of accelerator 422 is four tokens per processing iteration, thus accelerator 422 is determined to be at capacity. Overall, this system is determined to be unbalanced.

Attention will now be directed to FIG. 6B, which illustrates a new distribution of experts in order to achieve a balanced system status. In this example, the system identifies Expert D for removal from accelerator 412 because no tokens are assigned to accelerator 412. This opens up expert space on accelerator 412. Additionally, because accelerator 402 is overloaded, the system determines that relocating Expert B to accelerator 412 will allow for a balanced system. As shown in FIG. 6B, each accelerator is now processing at capacity to achieve a balanced system status.

It should be appreciated that while FIGS. 6A-6B show accelerators having the same capacity to store experts (e.g., two experts per accelerator) and the same capacity to process tokens (e.g., four tokens per accelerator), each accelerator may comprise a different capacity to store one or more experts and may comprise a different capacity to process one or more tokens. The computing system is beneficially configured to identify, from the available accelerators, the combination of accelerators that will yield a more balanced system than an initial combination, if there is an opportunity to redistribute experts to improve the processing efficiency of the computing system.

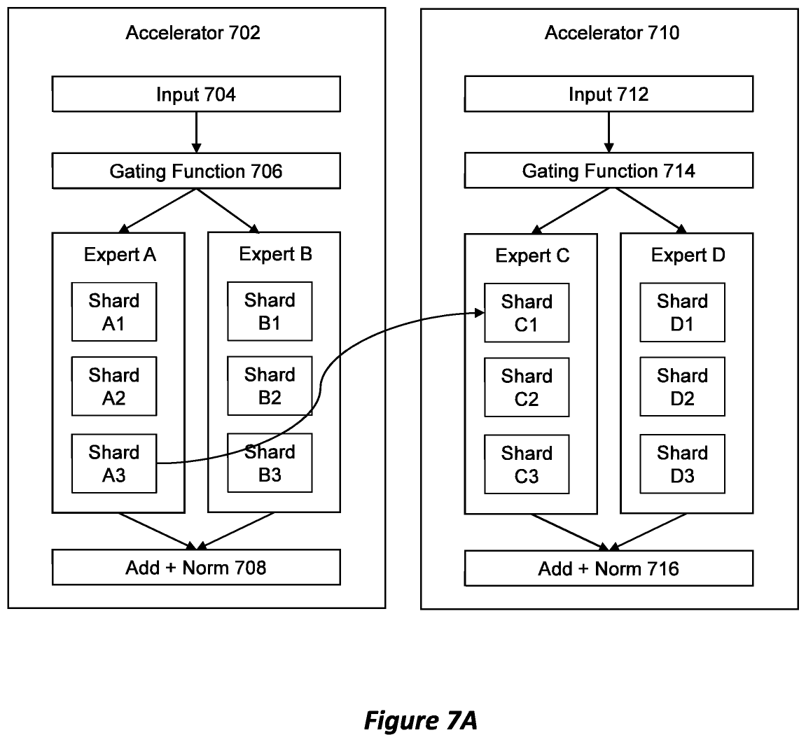

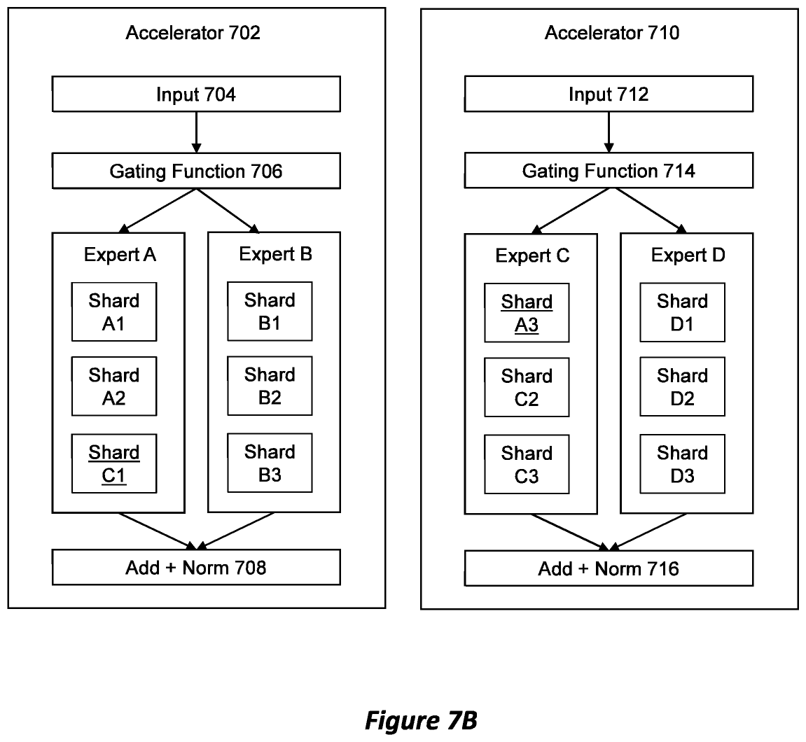

Attention will now be directed to FIGS. 7A-7B, which illustrate an alternate embodiment for redistributing experts on multiple accelerators by relocating a shard of an expert from one accelerator to another accelerator, removing a shard of an expert from an accelerator, and/or exchanging shards of different experts between accelerators. For example, as shown in FIG. 7A, each expert is segmented into a plurality of shards. Each shard comprises a fully functioning executable module that can be separated from the other modules of the expert and function on its own. Similar to how an expert is trained to perform a particular sub-task of a more complex task corresponding to the overall machine learning model, a shard is trained to perform a sub-subtask of the sub-task for which the corresponding expert is trained.

By way of example, if a particular sub-task associated with Expert A can be divided into three separate parts or functions, Expert A can be correspondingly segmented into three different shards, each associated with a different function (i.e., one or more shards per function/part). As shown in FIG. 7A, Expert A comprises Shard A1, Shard A2, and Shard A3. Expert B comprises Shard B1, Shard B2, and Shard B3. Expert C comprises Shard C1, Shard C2, and Shard C3. Expert D comprises Shard D1, Shard D2, and Shard D3. In such instances, input tokens can be assigned to a particular expert and/or a particular shard corresponding to an expert.

FIG. 7A also shows accelerator 702 comprising a gating function 706 which receives input 704 (e.g., input tokens), Expert A and its corresponding shards, Expert B and its corresponding shards, and an Add+Norm 708. Accelerator 710 is also shown having a gating function 714, Expert C and its corresponding shards, Expert D and its corresponding shards, and Add+Norm 716. In this example, the computing determines that the current distribution of experts and their corresponding shards could be altered to result in an improvement in the computational processing efficiency. For example, it is determined that Shard A3 and Shard C1 should be exchanged. The new distribution is shown in FIG. 7B, where accelerator 702 now stores Shard A1, Shard A2, and Shard C1 and where accelerator 710 now stores Shard A3, Shard C2, and Shard C3.

The following discussion now refers to several methods and method acts. Although the method acts may be discussed in certain orders or may be illustrated in a flow chart as occurring in a particular order, no particular ordering is required unless specifically stated, or required because an act is dependent on another act being completed prior to the act being performed.

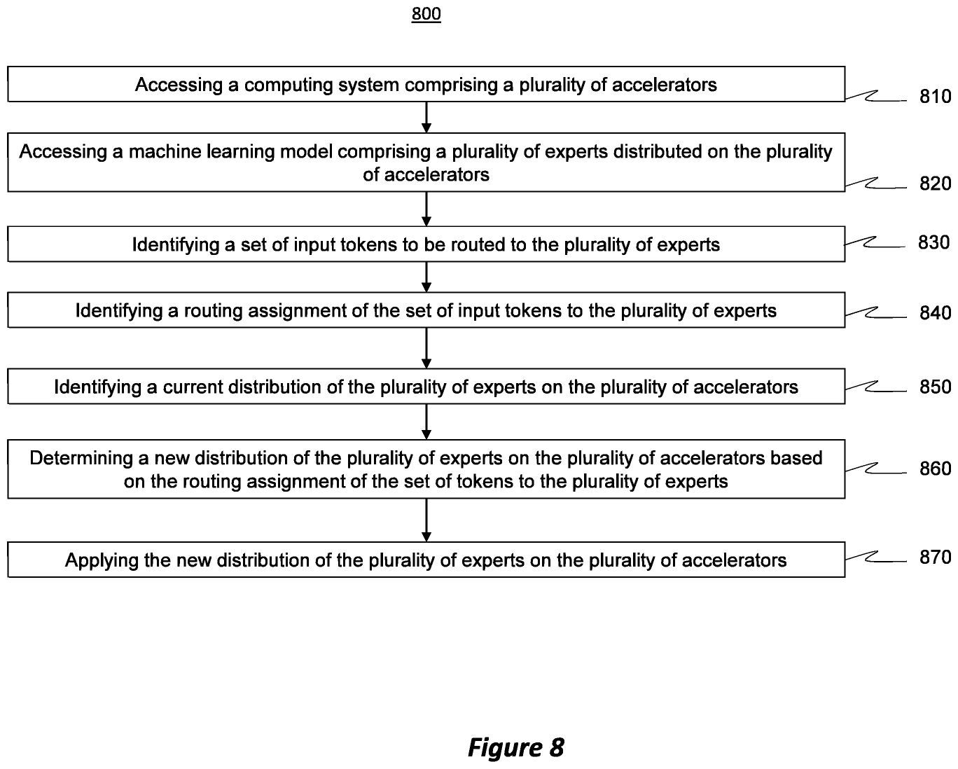

Attention will now be directed to FIG. 8, which illustrates a flow diagram 800 that includes various acts (act 810, act 820, act 830, act 840, act 850, act 860, and act 870) associated with exemplary methods that can be implemented by computing system 310 for redistributing a mixture-of-expert machine learning model onto the computing system. The following acts will also be described in relation to components illustrated throughout the figures.

The first illustrated act includes an act for accessing a computing system comprising a plurality of accelerators (e.g., dense accelerators 313, sparse accelerators 314) (act 810). The computing system also accesses a machine learning model (e.g., machine learning model 342) comprising a plurality of experts (e.g., experts 343) distributed on the plurality of accelerators (act 820). By utilizing a mixture-of-expert machine learning model, the system is able to customize the machine learning model by using a specific set of experts for each iteration or processing.

The system identifies a set of input tokens (e.g., input tokens 348) to be routed to the plurality of experts (act 830) and identifies a routing assignment (e.g., input token routing 401) of the set of input tokens to the plurality of experts (act 840). For example, systems access a dataset or index table that stores information about the relationships between the input tokens and the experts (and/or accelerators). Based on this routing assignment information, a system is able to identify and track which tokens have been processed, are being processed, or will be processed by the different experts. By identifying a routing assignment of the set of tokens, the system is able to determine how many tokens each expert is assigned. Additionally, the system identifies a current distribution of the plurality of experts on the plurality of accelerators (act 850) (see FIG. 4A). By identifying the current distribution, the system is able to determine how many tokens each accelerator will be processing. The system can then determine if there is an imbalance in the number of tokens being processed across multiple accelerators and/or if a particular accelerator is overloaded, at capacity, or underutilized.

Subsequently, the system determines a new distribution of the plurality of experts on the plurality of accelerators which will result in an improved processing efficiency of the set of input tokens by the plurality of accelerators based on the routing assignment of the set of tokens to the plurality of experts as compared to the current distribution of the plurality of experts on the plurality of accelerators (act 860) (see, for example, FIG. 4B). Finally, the system applies the new distribution of the plurality of experts on the plurality of accelerators. By applying the new distribution to the system, one or more experts are relocated to a different accelerator, removed from an accelerator, and/or exchanged between accelerators so that new inputs will be processed according to the new distribution of experts on the accelerators.

In some instances, applying the new distribution of the plurality of experts on the plurality of accelerators occurs prior to applying the machine learning model to the set of tokens. This is beneficial because it allows the computing system to preemptively improve computational processing efficiency.

Additionally, in some instances, the computing system also determines a particular number of iterations to process between determining if the new distribution of the plurality of experts should be applied. Then, the system performs the particular number of iterations prior to applying the new distribution of the plurality of experts on the plurality of accelerators. In some instances, an iteration refers to an instance of updating the model's parameters based on information/feedback learned by processing a particular set of input tokens. Sometimes, a model's parameters are updated at specific time intervals or based on a number of tokens processed. Additionally, or alternatively, an iteration refers to processing a discrete set of input tokens. For example, a first iteration processes a first set of input tokens, a second iteration processes a second set of input tokens, etc. Thus, in some instances, it is beneficial to utilize computing system resources (e.g., time and/or processing power) to analyze a current distribution of experts, identify inefficiencies, and generate a new distribution after every iteration to have an up-to-date distribution based on the latest iteration. Alternatively, in some instances, it is beneficial to wait a predetermined number of iterations before changing any distribution of the plurality of experts. By implementing a method in this manner, the system is able to tune and control when the system determines and applies a new distribution during multi-iteration processing.

It should be appreciated that the new distribution of experts can occur according to several different techniques, including relocation to an existing or new accelerator, removal from a particular accelerator, duplication of experts, exchange of experts between accelerators, and/or a combination thereof. For example, in some instances applying the new distribution of experts on the plurality of accelerators comprises relocating an expert from an accelerator that is determined to be overloaded to an underutilized accelerator.

In some instances, applying the new distribution of the plurality of experts on the plurality of accelerators comprises duplicating an overloaded expert on a particular accelerator to perform parallel processing of input tokens by a set of duplicate experts. Additionally, or alternatively, the system is able to (i) identify one or more experts that will not be used to process input tokens based on the routing assignment of the set of tokens to the plurality of experts and (ii) remove one or more experts that will not be used from one or more corresponding accelerators.

In some instances, an expert is temporarily removed from an accelerator for a certain period of time and is subsequently relocated back to the accelerator. For example, in such instances, a system processes a first set of input tokens according to a first input token routing assignment which would overload a particular accelerator, wherein the system determines to remove an expert from the particular accelerator. Subsequently, the system processes a second set of input tokens according to a second input token routing assignment, wherein the system determines to move the expert back to the accelerator because the second input token routing assignment will not overload the particular accelerator if the expert is stored thereon.

Different events are able to trigger a new distribution or redistribution of experts, including identifying an overloaded accelerator, or an underutilized accelerator, determining an overall unbalanced system status, predicting and/or identifying a dropped token, and/or identifying a potential improvement in processing efficiency. For example, in some instances, determining a new distribution of the plurality of experts is performed in response to proactively predicting that an overloaded accelerator will likely drop an input token directed to the overloaded accelerator in the current distribution, and such that identifying the expert to be relocated is based on determining that the expert is currently located on the overloaded accelerator. The triggering can also be based on proactively predicting a new and currently unapplied processing load that is anticipated to be applied to the overloaded accelerator or an under-utilized accelerator that will cause overloading, such as based on detecting the system instantiating a new program that is historically associated with a particular processing load for the referenced accelerator(s) (e.g., based on tracked historical data).

In some systems, experts are further divided into one or more shards corresponding to the experts, as illustrated in FIGS. 7A-7B. As noted previously, each shard comprises a fully functioning executable module that can be separated from the other modules of the expert and function independently from the other modules of the same expert. Similar to how an expert is trained to perform a particular sub-task of a more complex task corresponding to the overall machine learning model, a shard is trained to perform a sub-subtask of the sub-task for which the corresponding expert is trained. In such systems, the systems segment one or more experts into a plurality of shards. This is beneficial because the distribution of experts can now become a distribution of shards on multiple accelerators to fine-tune and further improve the processing efficiency of the computing system because the system is able to distribute or redistribute the machine learning model at a finer granularity using individual shards, instead of whole experts. Thus, applying the new distribution of the plurality of experts on the plurality of accelerators, in some instances, comprises relocating at least one shard from a first accelerator to a second accelerator and leaving at least one shard located on the first accelerator.

As described above, in some systems, at least some accelerators of the plurality of accelerators have a greater memory capacity than other accelerators and at least some accelerators have a greater processing capability than other accelerators which allows for a customized computing system. Furthermore, the machine learning model comprises a plurality of dense layers and a plurality of sparse layers, each sparse layer further comprising one or more experts of the plurality of experts. Thus, the machine learning model can be beneficially distributed on the plurality of accelerators so that the plurality of dense layers of the machine learning model is distributed on one or more accelerators having the greater processing capability and the plurality of sparse layers of the machine learning model is distributed on one or more accelerators having the greater memory capability.

In this manner, sparse layers and dense layers are segregated into separate groups and each group is assigned its own set of accelerators. By distributing the machine learning model according to this configuration, computing systems are able to achieve technical advantages, including the ability to apply specific performance optimizations that are suitable for dense computations and sparse computations in a selective manner. Additionally, MOE layers, such as sparse layers that comprise one or more experts, incorporate heavy communication overheads. Thus, configurations which distribute sparse layers and dense layers onto separate accelerators enable the system to exploit higher communication bandwidth available within a subset of the cluster (e.g., on a single node or nodes in a single rack). Furthermore, by distributing a machine learning model in this manner, a single set of MOE layers can be scheduled to process multiple interleaving inputs to increase the model throughput (either for training, inference, and/or implementation) efficiently.

It should be appreciated that each accelerator can store any number of experts. For example, in some instances, the plurality of experts is distributed evenly across the plurality of accelerators in the new distribution. Alternatively, each accelerator comprises a varying number of experts in the new distribution.

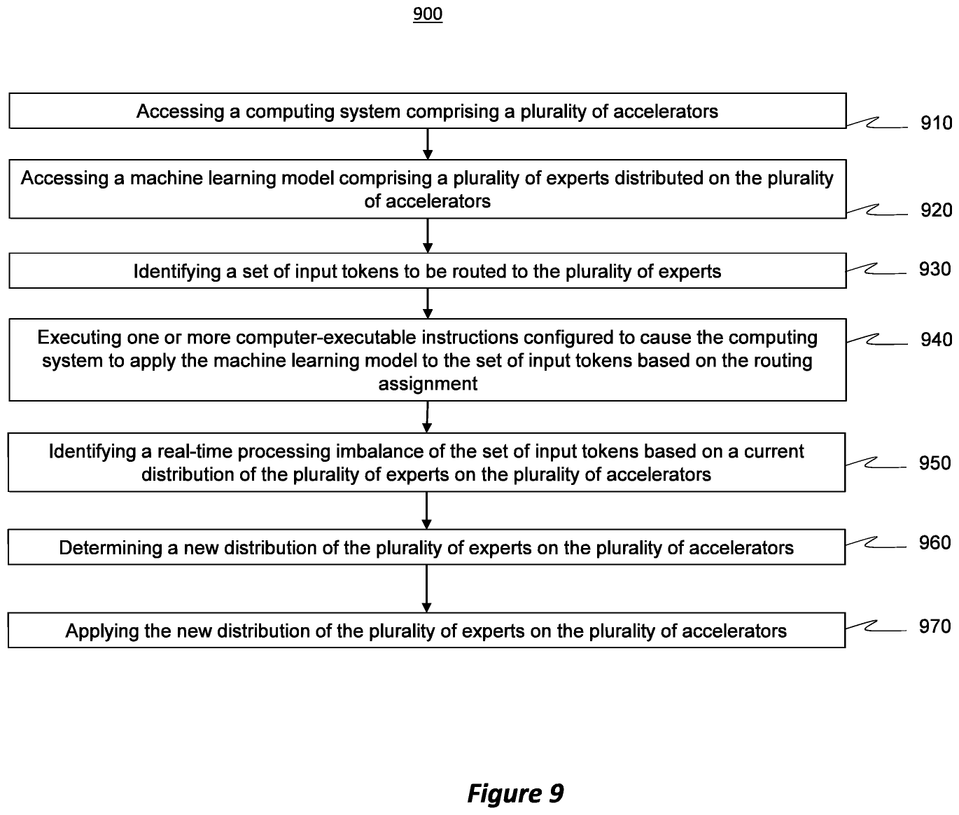

Attention will now be directed to FIG. 9, which illustrates a flow diagram 900 that includes various acts (act 910, act 920, act 930, act 940, act 950, act 960, and act 970) associated with exemplary methods that can be implemented by computing system 310 for redistributing a mixture-of-expert machine learning model onto the computing system.

The first illustrated act includes an act accessing a computing system (e.g., computing system 310) comprising a plurality of accelerators (act 910). The system also accesses a machine learning model (e.g., machine learning model 342) comprising a plurality of experts (e.g., experts 343) distributed on the plurality of accelerators (act 920) and identifies a set of input tokens (e.g., input tokens 348) to be routed to the plurality of experts (act 930). By utilizing a mixture-of-expert machine learning model, the system is able to customize the machine learning model by using a specific set of experts for each iteration or processing. Furthermore, by identifying the set of input tokens, the system is able to track where each input token will be processed in the different machine-learning layers. Next, the system executes one or more computer-executable instructions (e.g., computer-executable instructions 318) configured to cause the computing system to apply the machine learning model to the set of input tokens based on a routing assignment (e.g., input token routing 401) of the set of tokens to the plurality of experts (act 940). The systems then identify a real-time processing imbalance of the set of input tokens based on a current distribution of the plurality of experts on the plurality of accelerators (act 850) (see, for example, FIG. 4A). By identifying a real-time processing imbalance, the system is able to dynamically respond and redistribute the experts in order to fix the imbalance quickly.

Subsequently, the system determines a new distribution of the plurality of experts on the plurality of accelerators which will result in an improved balanced processing of the set of input tokens by the plurality of accelerators based on the routing assignment of the set of tokens to the plurality of experts as compared to the current distribution of the plurality of experts on the plurality of accelerators (act 960) and applies the new distribution of the plurality of experts on the plurality of accelerators (act 970) (see, for example, FIG. 4B).

It should be noted that there are many techniques or triggers for identifying a real-time or near real-time processing imbalance. For example, in some instances, identifying a real-time processing imbalance of the set of tokens comprises identifying an accelerator that is determined to be overloaded.

In some instances, identifying a real-time processing imbalance of the set of tokens comprises identifying an underutilized accelerator. In some instances, identifying a real-time processing imbalance of the set of tokens is based on determining that an accelerator has dropped an input token. Additionally, or alternatively, identifying a real-time processing imbalance of the set of tokens is based on determining that a first accelerator is processing more tokens than a second accelerator. In such instances, applying the new distribution comprises relocating a particular expert from the first accelerator to the second accelerator.

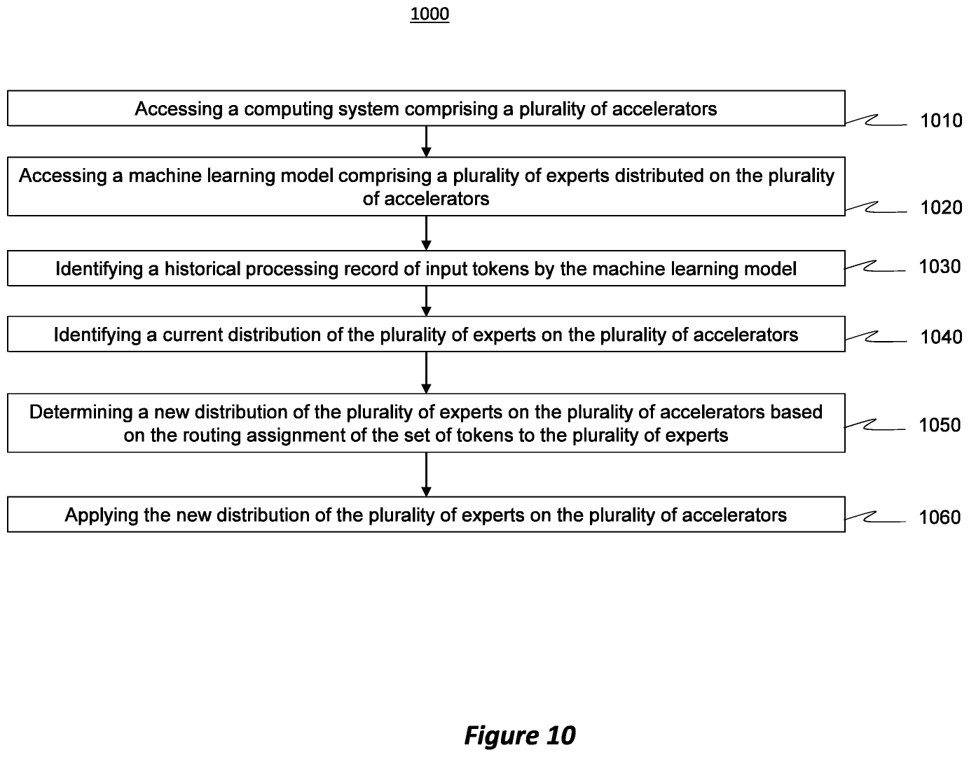

Attention will now be directed to FIG. 10, which illustrates a flow diagram 1000 that includes various acts (act 1010, act 1020, act 1030, act 1040, act 1050, act 1060, and act 1070) associated with exemplary methods that can be implemented by computing system 310 for redistributing a mixture-of-expert machine learning model onto the computing system.

The first illustrated act includes an act for accessing a computing system (e.g., computing system 310) comprising a plurality of accelerators (e.g., dense accelerators 313 and sparse accelerators 314) (act 1010) and accessing a machine learning model comprising a plurality of experts (e.g., experts 343) distributed on the plurality of accelerators (act 1020). The system also identifies a historical processing record of input tokens by the machine learning model (act 1030). The system identifies a current distribution of the plurality of experts on the plurality of accelerators (act 1040) (see, for example, FIG. 4A). Then, the system is able to determine a new distribution of the plurality of experts on the plurality of accelerators which will result in an improved and/or balanced processing of the set of input tokens by the plurality of accelerators based on the historical processing record of the set of tokens by the plurality of experts as compared to the current distribution of the plurality of experts on the plurality of accelerators (act 1050) and apply the new distribution of the plurality of experts on the plurality of accelerators (see, for example, FIG. 4B).

In some instances, systems also, based on the historical processing record, identify an accelerator that is determined to be overloaded and relocate a particular expert from the overloaded accelerator to an underutilized accelerator (see, for example, FIGS. 6A-6B). Additionally, or alternatively, based on the historical processing record, the system identifies an accelerator that is determined to be overloaded and exchanges a first expert from the overloaded accelerator with a second expert from an underutilized accelerator to balance the future processing of a set of input tokens by the plurality of experts on the plurality of accelerators.

### Example Computing Systems

Embodiments of the disclosure may comprise or utilize a special-purpose or general-purpose computer system (e.g., computer system 310) that includes computer hardware, such as, for example, a processor system (e.g., hardware processor(s) 312) and system memory (e.g., hardware storage device(s) 340), as discussed in greater detail below. Embodiments within the scope of the present disclosure also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality.

Transmission media can include a network and/or data links that can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

It will be appreciated that the disclosed systems and methods may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Embodiments of the disclosure may also be practiced in distributed system environments where local and remote computer systems, which are linked (either by hardwired data links, wireless data links, or by a combination of hardwired and wireless data links) through a network, which both perform tasks. As such, in a distributed system environment, a computer system may include a plurality of constituent computer systems. In a distributed system environment, program modules may be located in both local and remote memory storage devices.

It will also be appreciated that the embodiments of the disclosure may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as, for example, Software as a Service (SaaS), Platform as a Service (PaaS), and Infrastructure as a Service (IaaS). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from the view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources include processing capacity, memory, disk space, network bandwidth, media drives, and so forth.

What is claimed:

1. A method for distributing experts of a machine learning model on a computing system, the method comprising:
accessing a computing system comprising a plurality of accelerators;
accessing a machine learning model comprising a plurality of experts distributed on the plurality of accelerators;
identifying a set of input tokens to be routed to the plurality of experts;
identifying a routing assignment of the set of input tokens to the plurality of experts;
identifying a current distribution of the plurality of experts on the plurality of accelerators;
determining a new distribution of the plurality of experts on the plurality of accelerators based on the routing assignment of the set of tokens to the plurality of experts as compared to the current distribution of the plurality of experts on the plurality of accelerators; and
applying the new distribution of the plurality of experts on the plurality of accelerators.

2. The method of claim 1, wherein applying the new distribution of the plurality of experts on the plurality of accelerators occurs prior to applying the machine learning model to the set of tokens.

3. The method of claim 1, further comprising:
determining a particular number of iterations to process between determining if the new distribution of the plurality of experts should be applied; and
performing the particular number of iterations prior to applying the new distribution of the plurality of experts on the plurality of accelerators.

4. The method of claim 1, wherein applying the new distribution of experts on the plurality of accelerators comprises relocating an expert from an accelerator that is determined to be overloaded to an underutilized accelerator.

5. The method of claim 5, wherein determining a new distribution of the plurality of experts is performed in response to predicting that an overloaded accelerator will likely drop an input token directed to the overloaded accelerator in the current distribution, and such that identifying the expert to be relocated is based on determining that the expert is currently located on the overloaded accelerator.

6. The method of claim 1, wherein applying the new distribution of the plurality of experts on the plurality of accelerators comprises duplicating an overloaded expert on a particular accelerator to perform parallel processing of input tokens by a set of duplicate experts.

7. The method of claim 1, further comprising:
identifying one or more experts that will not be used to process input tokens based on the routing assignment of the set of tokens to the plurality of experts; and
removing the one or more experts from one or more corresponding accelerators.

8. The method of claim 1, further comprising:
segmenting one or more experts into a plurality of shards,
wherein applying the new distribution of the plurality of experts on the plurality of accelerators comprises relocating at least one shard from a first accelerator to a second accelerator and leaving at least one shard located on the first accelerator.

9. The method of claim 1, wherein at least some accelerators of the plurality of accelerators have a greater memory capacity than other accelerators and at least some accelerators have a greater processing capability than other accelerators.

10. The method of claim 9,
wherein the machine learning model comprises a plurality of dense layers and a plurality of sparse layers, each sparse layer further comprising one or more experts of the plurality of experts, and
wherein the machine learning model is distributed on the plurality of accelerators such that the plurality of dense layers of the machine learning model is distributed on one or more accelerators having the greater processing capability and the plurality of sparse layers of the machine learning model is distributed on one or more accelerators having the greater memory capability.

11. The method of claim 1, wherein the plurality of experts is distributed evenly across the plurality of accelerators in the new distribution.

12. A method for distributing experts of a machine learning model on a computing system, the method comprising:
accessing a computing system comprising a plurality of accelerators;
accessing a machine learning model comprising a plurality of experts distributed on the plurality of accelerators;
identifying a set of input tokens to be routed to the plurality of experts;
executing one or more computer-executable instructions configured to cause the computing system to apply the machine learning model to the set of input tokens based on the routing assignment;
identifying a real-time processing imbalance of the set of input tokens based on a current distribution of the plurality of experts on the plurality of accelerators;
determining a new distribution of the plurality of experts on the plurality of accelerators which will result in an improved balanced processing of the set of input tokens by the plurality of accelerators based on the routing assignment of the set of tokens to the plurality of experts as compared to the current distribution of the plurality of experts on the plurality of accelerators; and
applying the new distribution of the plurality of experts on the plurality of accelerators.

13. The method of claim 12, wherein identifying a real-time processing imbalance of the set of tokens comprises identifying an accelerator that is determined to be overloaded.

14. The method of claim 12, wherein identifying a real-time processing imbalance of the set of tokens comprises identifying an underutilized accelerator.

15. The method of claim 12, wherein identifying a real-time processing imbalance of the set of tokens is based on determining that an accelerator has dropped an input token.

16. The method of claim 12, wherein identifying a real-time processing imbalance of the set of tokens is based on determining that a first accelerator is processing more tokens than a second accelerator.

17. The method of claim 16, wherein applying the new distribution comprises relocating a particular expert from the first accelerator to the second accelerator.

18. A method for distributing experts of a machine learning model on a computing system, the method comprising:
accessing a computing system comprising a plurality of accelerators;
accessing a machine learning model comprising a plurality of experts distributed on the plurality of accelerators;
identifying a historical processing record of input tokens by the machine learning model;
identifying a current distribution of the plurality of experts on the plurality of accelerators;
determining a new distribution of the plurality of experts on the plurality of accelerators which will result in an improved balanced processing of the set of input tokens by the plurality of accelerators based on the historical processing record of the set of tokens by the plurality of experts as compared to the current distribution of the plurality of experts on the plurality of accelerators; and
applying the new distribution of the plurality of experts on the plurality of accelerators.

19. The method of claim 18, further comprising:
based on the historical processing record, identifying an accelerator that is determined to be overloaded; and
relocating a particular expert from the overloaded accelerator to an underutilized accelerator.

20. The method of claim 18, further comprising:
based on the historical processing record, identifying an accelerator that is determined to be overloaded; and
interchanging a first expert from the overloaded accelerator with a second expert from an underutilized accelerator to balance a future processing of a set of input tokens by the plurality of experts on the plurality of accelerators.
